(19) United States
(12) Patent Application Publication
(10) Pub. No.: US 2020/0356358 A1
(43) Pub. Date: Nov. 12, 2020

(54) SYSTEMS AND METHODS FOR INCREMENTALLY AND DYNAMICALLY UPDATING FIRMWARE

(71) Applicant: DELL PRODUCTS L.P., Round Rock, TX (US)

(72) Inventors: Prashanth GIRI, Round Rock, TX (US); Murali Krishna SOMAROUTHU, Austin, TX (US); Chandrasekhar PUTHILLATHE, Bangalore (IN); Ashok Narayanan POTTI, Bangalore (IN); Naveen GOPALA, Bangalore (IN); Rajeshkumar Ichchhubhai PATEL, Bangalore (IN)

(73) Assignee: DELL PRODUCTS L.P., Round Rock, TX (US)

(21) Appl. No.: 16/405,692

(22) Filed: May 7, 2019

(51) Int. Cl. G06F 8/658; G06F 21/57; G06F 16/18

(52) U.S. Cl. CPC G06F 8/658; G06F 16/1805; G06F 21/575

(57) ABSTRACT

Presented are scalable systems and methods for dynamically and incrementally updating a file system to patch firmware in an embedded device deployed in the field. In various embodiments, advantageously, the update and release process of, e.g., Linux-based firmware may be accomplished by using a simplified patching process that updates the firmware without having to update or replace the entire file system. As a result, a patch, e.g., security fix to existing firmware in the field, can be provided to customers relatively quickly, e.g., prior to a full firmware release that incorporates the fix is made available later on, thereby, eliminating traditional, full-image upgrades that are subject to time consuming release cycles, space constraints, and other limitations.

### BACKGROUND

The present disclosure relates generally to file systems. More particularly, the present disclosure relates to systems and methods for providing an update to a file system, e.g., to patch firmware in the field, without updating an entire file system.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use, such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In general, for embedded systems-based devices operating on Linux or Linux-based systems, firmware is built, bundled, and deployed as a single, monolithic image rather than as individual applications. The main reason for adopting such a methodology is that devices generally have firmware images that contain read-only file systems, which are read-only and, therefore, files that are to be patched cannot be simply overwritten. Instead the entire file system has to be updated as a whole. Compared to read-write file systems, having read-only file systems in embedded system environments has several advantages, including enhanced tamper-resistance, lower space requirements, and so on.

Typically, the end device has active and standby partitions that host current and previous versions of the firmware. Whenever a firmware update is initiated on the device, the update overwrites/updates the alternate (i.e., standby) partition with the updated image and boots to it. In any event, the update completely flashes the alternative partition.

From a firmware release point of view, a complete new image must be built, tested, and released, even for a small, but sometimes critical, e.g., security-related fixes. The process and effort involved in the release cycle is, thus, significant and time consuming. A typical release cycle involves thorough planning, estimation, and execution by core team, program development & test teams, release management team, and factory. Re-spinning cycles can last anywhere from few weeks to months, depending on the features/fixes to be implemented and the urgency of the update itself. For example, in case of a high-visibility security vulnerability in the firmware, it may be necessary to spin an image with a fix and get it into the hand of customers as soon as possible, since the longer customers operate using vulnerable firmware, the higher will be the likelihood that an attack on the system will be successful.

Accordingly, it is desirable to provide improved systems and methods that, for example, to protect vulnerable firmware from unwanted attacks, allow for dynamic, incremental patching of firmware in the field to simplify the update and release process, while eliminating traditional, full-image upgrades that are subject to time consuming release cycles, space constraints, and other limitations.

### BRIEF DESCRIPTION OF THE DRAWINGS

References will be made to embodiments of the disclosure, examples of which may be illustrated in the accompanying figures. These figures are intended to be illustrative, not limiting. Although the accompanying disclosure is generally described in the context of these embodiments, it should be understood that it is not intended to limit the scope of the disclosure to these particular embodiments. Items in the figures may be not to scale.

FIG. 1 depicts a file system hierarchy for dynamically updating a file system, according to embodiments of the present disclosure.

FIG. 2 is a flowchart for dynamically updating a file system, according to embodiments of the present disclosure.

FIG. 3 illustrates exemplary patch packaging for use in dynamically updating a file system, according to embodiments of the present disclosure.

FIG. 4 illustrates an exemplary layout for two files for use in dynamically updating a file system, according to embodiments of the present disclosure.

FIG. 5 is a flowchart of an illustrative process for using a server to dynamically update a file system, according to embodiments of the present disclosure.

FIG. 6 depicts a simplified block diagram of an information handling system according to embodiments of the present invention.

FIG. 7 depicts an alternative block diagram of an information handling system, according to embodiments of the present disclosure.

### DETAILED DESCRIPTION OF THE PREFERRED EMBODIMENTS

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system/device, or a method on a tangible computer-readable medium.

Components, or modules, shown in diagrams are illustrative of exemplary embodiments of the disclosure and are meant to avoid obscuring the disclosure. It shall also be understood that throughout this discussion components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

The use of certain terms in various places in the specification is for illustration and should not be construed as limiting. The terms “include,” “including,” “comprise,” and “comprising” shall be understood to be open terms and any lists the follow are examples and not meant to be limited to the listed items.

A service, function, or resource is not limited to a single service, function, or resource; usage of these terms may refer to a grouping of related services, functions, or resources, which may be distributed or aggregated. The use of memory, database, information base, data store, tables, hardware, and the like may be used herein to refer to system component or components into which information may be entered or otherwise recorded. The terms “data,” “information,” along with similar terms may be replaced by other terminologies referring to a group of bits, and may be used interchangeably. The terms “packet” or “frame” shall be understood to mean a group of bits. The term “frame” shall not be interpreted as limiting embodiments of the present invention to Layer 2 networks; and, the term “packet” shall not be interpreted as limiting embodiments of the present invention to Layer 3 networks. The terms “packet,” “frame,” “data,” or “data traffic” may be replaced by other terminologies referring to a group of bits, such as “datagram” or “cell.” The term “firmware” equally applies to both hardware and software implementations of the embodiments presented herein.

It shall be noted that: (1) certain steps may optionally be performed; (2) steps may not be limited to the specific order set forth herein; (3) certain steps may be performed in different orders; and (4) certain steps may be done concurrently.

It shall further be noted that although embodiments described herein may be within the context of a Linux-based embedded system environment, aspects of the present disclosure are not so limited. Accordingly, the aspects of the present disclosure may be applied or adapted for use in other computing environments.

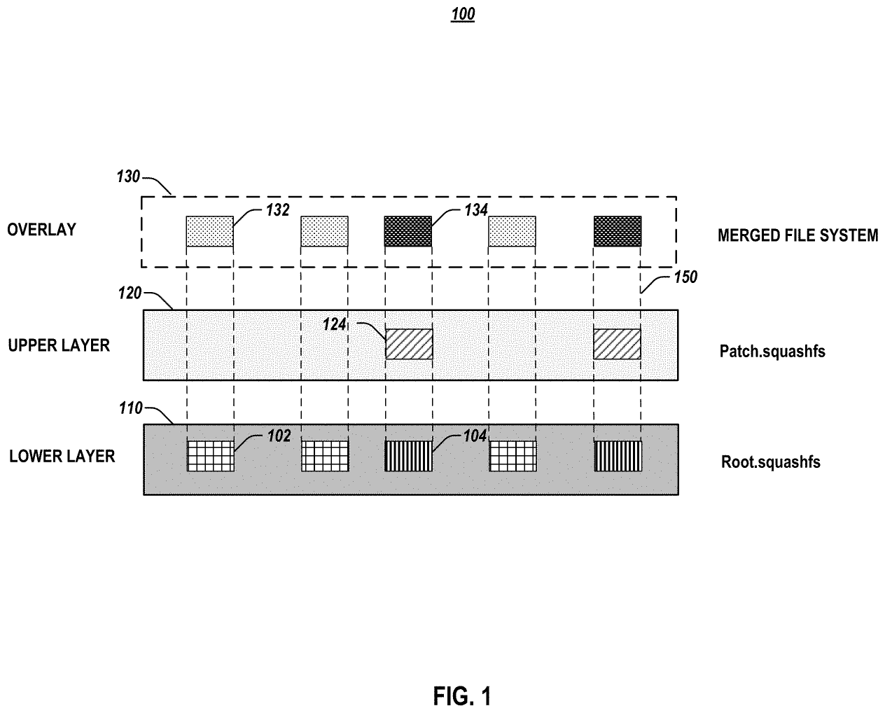

FIG. 1 depicts a system for dynamically updating a file system, according to embodiments of the present disclosure. System 100 comprises lower layer 110 and upper layer 120 that when combined produce overlay 130. As discussed further below, in embodiments, system 100 implements a hierarchy that prioritizes upper layer 120 and its contents over lower layer 110 and its contents. In embodiments, upper layer comprises a patch file system or patch image comprising re-spun or updated files 124 that comprise updates intended to replace outdated or vulnerable files 104 in the firmware, e.g., in lower layer 110 in devices that operate in the field.

FIG. 1 depicts lower layer 110 as a typical embedded Linux-based firmware file systems that is built as compressed read-only images, here, labeled root.squashfs. Such images generally comprise the entire firmware binary files and related dependencies in one binary large object (blob). Since the root filesystem is a read-only filesystem, it traditionally cannot be patched by replacing any affected components or binaries therein.

Therefore, in order to dynamically patch images in such file systems that are read-only except by complete replacement, various embodiments take advantage of an overlaying mechanism that allows a secondary file system to be overlaid on top of an existing file-system. In embodiments, such stacking of file systems may create a compounding effect that combines features of both individual file systems in lower layer 110 and one or more upper layers 120 in the stack.

As a result, in embodiments, a patch, i.e., specific binaries or files 124 may be applied to firmware, advantageously, without having to resort to traditional, full-image upgrades that rely on a develop team incorporating file(s) 124 into a custom build that requires a considerable amount of testing before it can be formally released. A minimal re-spin cycle for firmware can be achieved and a quick-fix/work-around can be made available to customers in a relatively short time.

In embodiments, complete replacement of a read-only file system is enables in response to an authorization. As shown in FIG. 1, lower layer 110 may be a read-only root file system, e.g., the main root filesystem that is installed in a device, and upper layer 120 may be a patch filesystem (comprising fixed files or binaries 124). While both depicted file systems are read-only filesystem images, this is not intended as limitation on the scope of the invention. In embodiments, when lower layer 110 and upper layer 120 are overlaid, files present in upper layer 120 may take precedence over corresponding files in lower layer(s) 110, e.g., files having the same name. In embodiments, this results in virtually overwriting existing binaries 104 with newer ones 124 from upper layer 120 without actually overwriting files. Stated differently, the overlaying mechanism emulates dynamic patching of binaries/files 104 on the fly. In embodiments, once the patched image in upper layer 120 that comprises fixed/re-spun binaries 124 is mounted over the original root file system in lower layer 110, the patched file(s) 124 mask out the original affected or outdated file(s) 104 in lower layer 110 such these cannot be accessed or “viewed.”

In FIG. 1, upper layer 120 (represented by patch.squashfs) comprises files 124 that are being used as a patch, and lower layer 110 (represented by original rootfs.squashfs) comprises the original set of files 102 and 104. In embodiments, when a patch or patch file system is overlaid on the original root file system, the resulting merged file system 130 comprises a combination of both upper layer 120 and lower layer 110 files.

In embodiments, file(s) 124 in upper layer 120 are assigned a higher priority than file(s) 104 in lower layer 110, effectively overwriting target files 104, without affecting other, non-target files 102 in the original root file system, as indicated by dotted lines 150. In embodiments, several patch images may be generated and applied one on top of the other, each later patch image having a higher priority than other patch images, effectively overriding some or all lower levels patch images.

Various embodiments take advantage of the read-write capability that the merged file system provides, e.g., to a DVD, by mounting overlay 130 as a temporary file system on top of the read-only file system in lower layer 110 to enable a patch or software update. It is noted that while FIG. 1 is described in the context of overlay 130, an overlay file system is not essential to accomplishing the objectives of the present disclosure, as any other mount file system may be created and implemented, in accordance with the teachings of the present disclosure. It is further noted that any number of layers or tiers may be mounted into the stack.

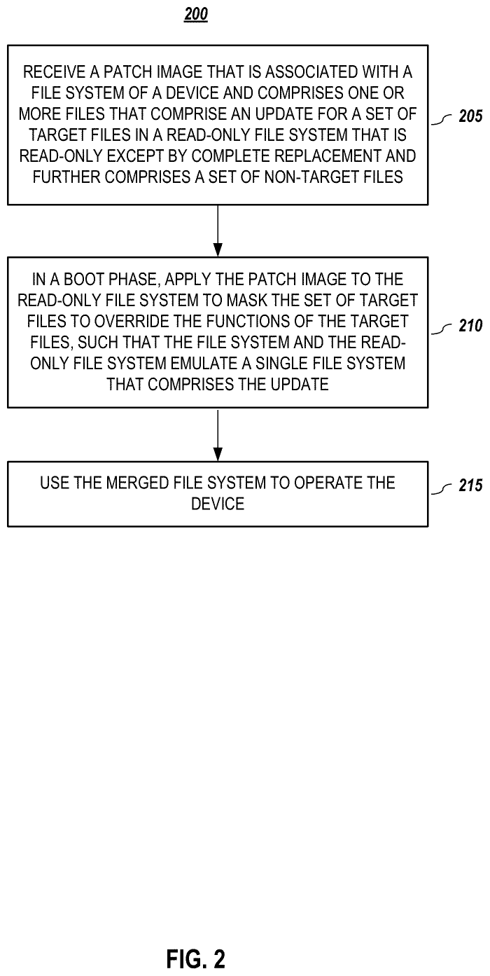

FIG. 2 is a flowchart of an illustrative process for dynamically updating a file system, according to embodiments of the present disclosure. In embodiments, process 200 begins when a patch image is received (205) that is associated with a file system of a device and comprises one or more files that comprise an update for a set of target files in a read-only file system. The read-only file system may comprise a set of non-target files.

In a boot phase, the patch image may be applied (210) to the read-only file system to mask the set of target files to override the functions of the target files without affecting the set of non-target files, such that the file system and the read-only file system emulate a single, merged file system that comprises the update.

Finally, the merged file system may be used (215) to operate the device.

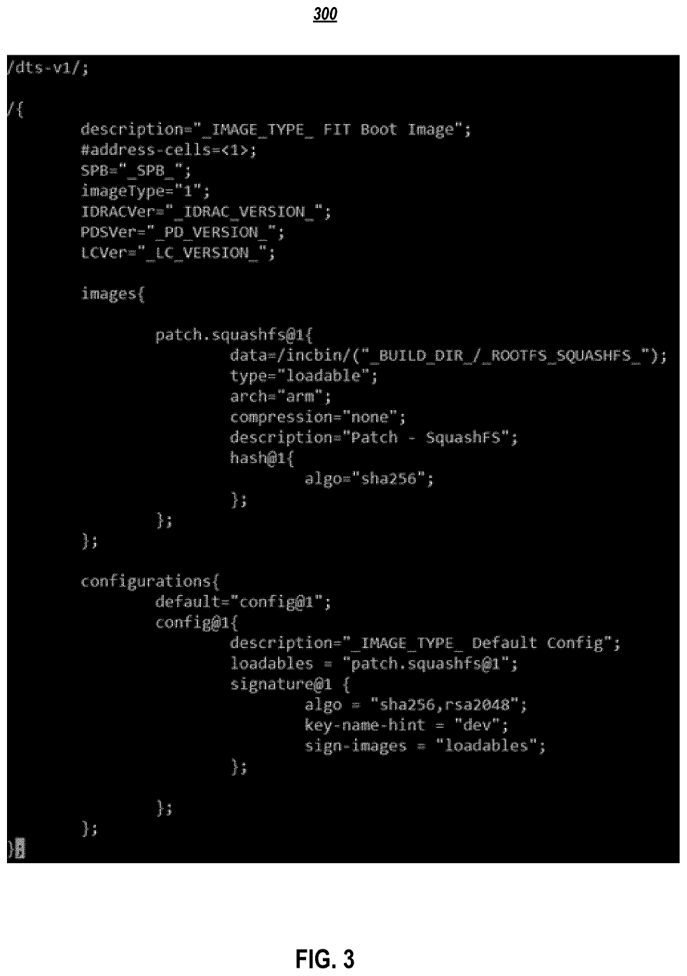

FIG. 3 illustrates exemplary patch packaging for use in dynamically updating a file system, according to embodiments of the present disclosure. As shown in the FIG. 3, a patch itself may be packaged as a flattened image tree (FIT) image, i.e., a FIT blob, or by using any other standard format. In embodiments, the contents of the FIT package may comprise the actual file system image that, in turn, comprises files that are to be updated and associated meta data.

In embodiments, the contents of patch file system are the actual files laid out in the file hierarchy standard paths. It is understood that there may be many different ways a patch may be packaged and delivered.

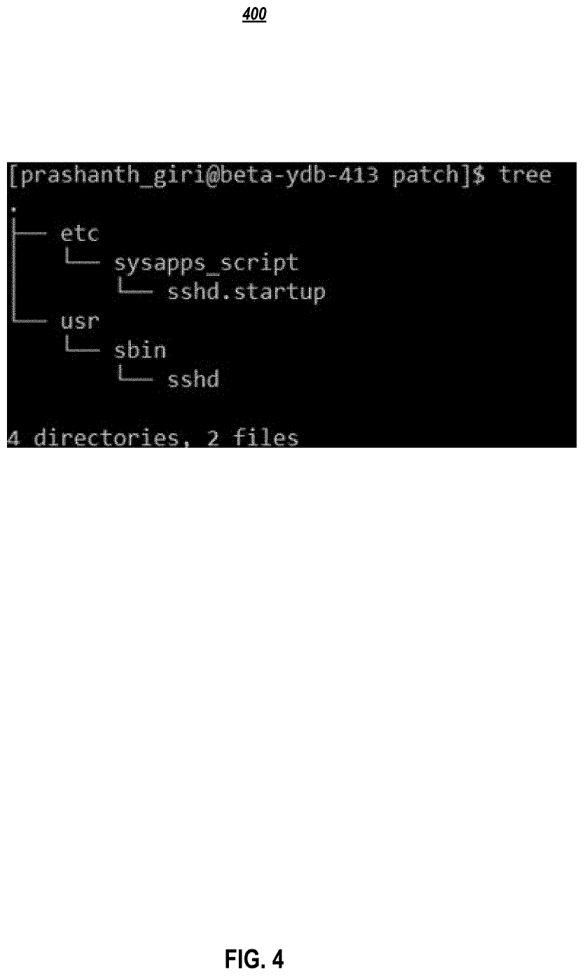

FIG. 4 illustrates an exemplary layout for two files for use in dynamically updating a file system, according to embodiments of the present disclosure. Depicted in FIG. 4 are the sshd binary in one directory and a startup script in another directory. In embodiments, once the patch is applied, it may be used to override existing files in respective directories of the lower layer file system (see FIG. 1).

It is noted that, for simplicity and compatibility reasons, a patch creation may be geared toward a specific release rather than being used as a global patch for all releases (which is technically possible). In embodiments, patch creation may comprise one or more of the following: updating the source code of a targeted component; building and packaging binaries/files (e.g., using original FHS paths) into a separate patch filesystem image; regression testing; performing release activities such as packaging; and providing an update to affected customers, who install the patch.

To install a patch, a customer may be prompted to download, e.g., a patch firmware image (see Table 1) and use any of the number of interfaces (e.g., an integrated Dell Remote Access Controller (iDRAC) interface) to initiate a firmware update. In embodiments, as part of a firmware update process, authentication of the patch firmware image, version checks, and the like may be performed, e.g., by using a public key authentication method, prior to installing the contents of the patch file system on, for example, an electronic Multi-Media Card partition. In embodiments, instead of a public key, a dm-verity based solution may be used for root files systems or patch file systems. For example, a Linux kernel may perform authentication using root hashes prior to mounting files. It is noted that if the patch firmware image fails one or more authentication checks or is not compatible with a currently running version of the firmware, the update process may be aborted.

In embodiments, on the next boot, e.g., after a successful firmware update, a temporary file system may be used to re-authenticate files in the upper layer and mount the upper layer on the main root file system before passing control to an initialization process on the main root file system. Advantageously, this provides for seamless integration of patches during a boot operation. In embodiments, the temporary file system may comprise a script that locates the actual root file system and existing patches, if any, and stacks those file systems prior to booting into the main file system.

In embodiments, the update process does not overwrite files; rather the new patch file system is copied onto an active partition. In embodiments, if the active partition is power-on lock protected, the patch file system may be staged in a temporary staging location, and, on a next reboot, initramfs may re-validate the file and copy to the active partition before power-on lock protecting the partition.

Table 1 shows exemplary Linux-based commands for use in dynamically updating a file system, according to embodiments of the present disclosure. In a Linux-based system, in embodiments, initramfs may use Linux overlayfs commands as shown in the table to mount the root file system and patch file system files during a boot operation.

TABLE 1

| mount -t overlay overlay -o lowerdir=/upper:/lower /merged | |
|---|---|
| /upper | -- mount point for patch.squashfs |
| /lower | -- mount point for rootfs.squashfs |
| /merged | -- mount point for combined overlayfs |

Embodiments presented herein have numerous benefits over existing upgrade methods that require that a complete new image be built for each upgrade. For example, reducing the file size of a patch (e.g., a set of binaries) to be created and tested, advantageously, shortens the duration of the release cycle. Various embodiments provide for a patch that may comprise a fix for a critical security issue, to be created, tested, and made available with significantly shortened turnaround times when compared to common full upgrade methods. Since a build according to embodiments disclosed herein comprises a fix with few libraries and/or executable files, testing resources may be saved by focusing on the specific fix rather than testing a complete image. As previously mentioned, more than one patch set may be generated and applied to override one or more earlier patches.

In embodiments, if a released patch is deemed incorrect or invalid, e.g., because an incorrect image was used, that patch may be removed, e.g., by undoing the patching process instead of re-spinning the whole image without that fix. In addition, users may feel more confident in applying a patch or image having a small footprint and that has been released and made available, e.g., at a customer support web site, rather than re-flashing the complete image.

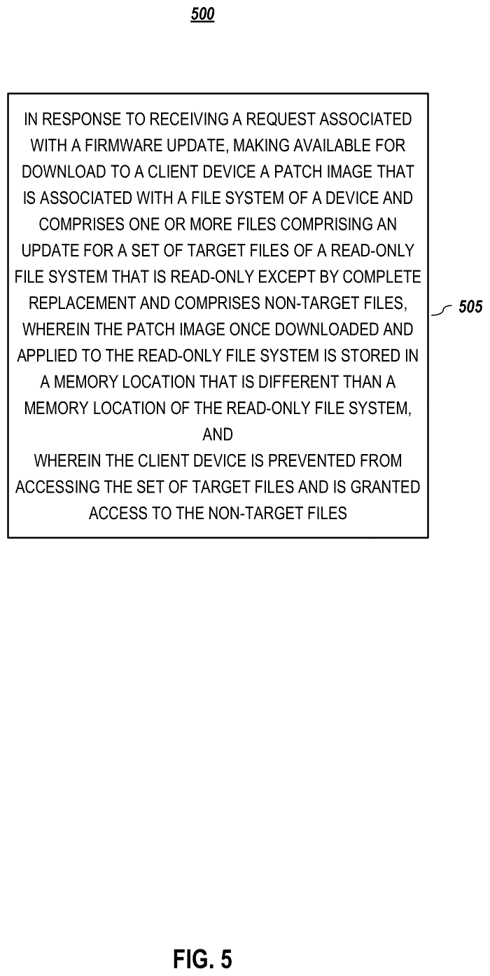

FIG. 5 is a flowchart of an illustrative process for using a server to dynamically update a file system, according to embodiments of the present disclosure. Process 500 begins when, in response to receiving a request associated with a firmware update, a patch image that is associated with a file system of a device and comprises one or more files comprising an update for a set of target files of a read-only file system that comprises non-target files is made available (505) for download to a client device.

In embodiments, the patch image, once downloaded and applied to the read-only file system, may be stored in a memory location that is different than a memory location of the read-only file system.

In embodiments, the client device may be prevented from accessing the set of target files and is granted access to the non-target files.

In one or more embodiments, aspects of the present patent document may be directed to, may include, or may be implemented on one or more information handling systems (or computing systems). An information handling system/computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a personal computer (e.g., laptop), tablet computer, mobile device (e.g., personal digital assistant (PDA), smart phone, etc.) smart watch, server (e.g., blade server or rack server), a network storage device, camera, or any other suitable device and may vary in size, shape, performance, functionality, and price. The computing system may include random access memory (RAM), one or more processing resources such as a central processing unit (CPU) or hardware or software control logic, ROM, and/or other types of memory. Additional components of the computing system may include one or more disk drives, one or more network ports for communicating with external devices as well as various input and output (I/O) devices, such as a keyboard, a mouse, touchscreen and/or a video display. The computing system may also include one or more buses operable to transmit communications between the various hardware components.

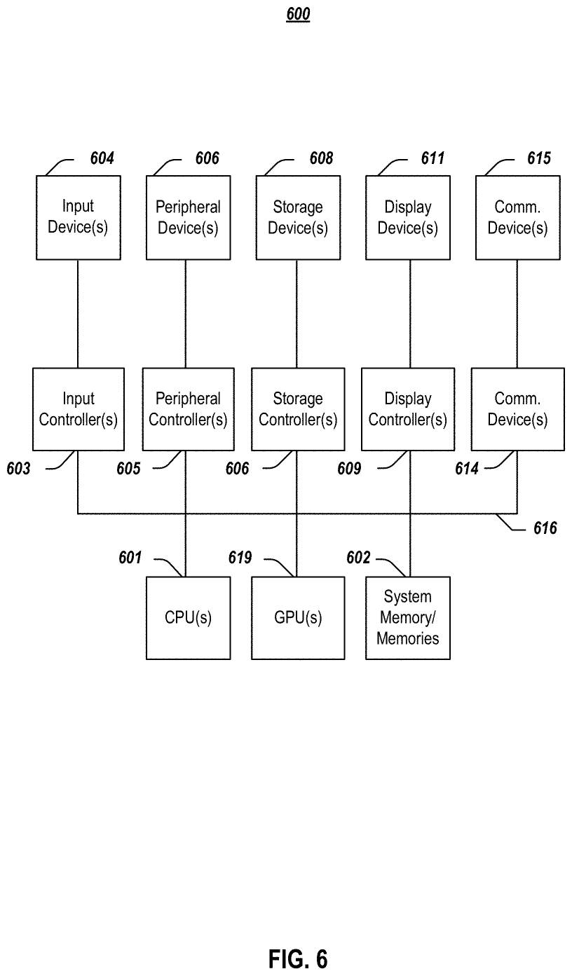

FIG. 6 depicts a simplified block diagram of an information handling system (or computing system) according to embodiments of the present disclosure. It will be understood that the functionalities shown for system 600 may operate to support various embodiments of a computing system—although it shall be understood that a computing system may be differently configured and include different components, including having fewer or more components as depicted in FIG. 6.

As illustrated in FIG. 6, the computing system 600 includes one or more central processing units (CPU) 601 that provides computing resources and controls the computer. CPU 601 may be implemented with a microprocessor or the like, and may also include one or more graphics processing units (GPU) 619 and/or a floating-point coprocessor for mathematical computations. System 600 may also include a system memory 602, which may be in the form of RAM, read-only memory (ROM), or both.

A number of controllers and peripheral devices may also be provided, as shown in FIG. 6. An input controller 603 represents an interface to various input device(s) 604, such as a keyboard, mouse, touchscreen, and/or stylus. The computing system 600 may also include a storage controller 607 for interfacing with one or more storage devices 608 each of which includes a storage medium such as magnetic tape or disk, or an optical medium that might be used to record programs of instructions for operating systems, utilities, and applications, which may include embodiments of programs that implement various aspects of the present disclosure. Storage device(s) 608 may also be used to store processed data or data to be processed in accordance with the disclosure. The system 600 may also include a display controller 609 for providing an interface to a display device 611, which may be a cathode ray tube (CRT), a thin film transistor (TFT) display, organic light-emitting diode, electroluminescent panel, plasma panel, or other type of display. The computing system 600 may also include one or more peripheral controllers or interfaces 605 for one or more peripherals 606. Examples of peripherals may include one or more printers, scanners, input devices, output devices, sensors, and the like. A communications controller 614 may interface with one or more communication devices 615, which enables the system 600 to connect to remote devices through any of a variety of networks including the Internet, a cloud resource (e.g., an Ethernet cloud, a Fiber Channel over Ethernet (FCoE)/Data Center Bridging (DCB) cloud, etc.), a local area network (LAN), a wide area network (WAN), a storage area network (SAN) or through any suitable electromagnetic carrier signals including infrared signals.

In the illustrated system, all major system components may connect to a bus 616, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable medium including, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices.

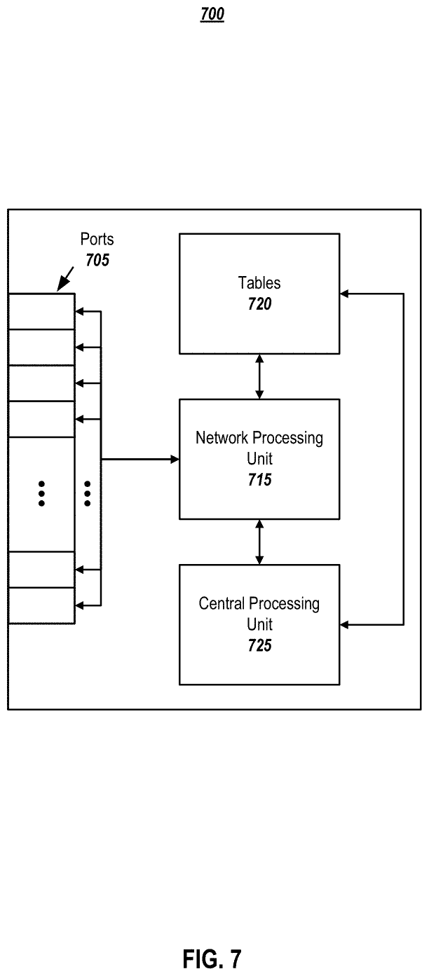

FIG. 7 depicts an alternative block diagram of an information handling system, according to embodiments of the present disclosure. It will be understood that the functionalities shown for system 700 may operate to support various embodiments of the present disclosure—although it shall be understood that such system may be differently configured and include different components (including fewer or more components).

The information handling system 700 may include a plurality of I/O ports 705, a network processing unit (NPU) 715, one or more tables 720, and a central processing unit (CPU) 725. The system includes a power supply (not shown) and may also include other components, which are not shown for sake of simplicity.

In one or more embodiments, the I/O ports 705 may be connected via one or more cables to one or more other network devices or clients. The network processing unit 715 may use information included in the network data received at the node 700, as well as information stored in the tables 720, to identify a next device for the network data, among other possible activities. In one or more embodiments, a switching fabric may then schedule the network data for propagation through the node to an egress port for transmission to the next destination.

Aspects of the present disclosure may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that have computer code thereon for performing various computer-implemented operations. The media and computer code may be those specially designed and constructed for the purposes of the present disclosure, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present disclosure. One skilled in the art will also recognize that a number of the elements described above may be physically and/or functionally separated into sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

1. A computer-implemented method for dynamically updating a read-only file system of a device, the method comprising:
receiving a first patch image that comprises one or more files that form an upper layer file system comprising an update for a set of target files for the read-only file system, the read-only file system further comprising a set of non-target files;
in a boot phase, applying the upper layer file system to the read-only file system to mask the set of target files to override the functions of the set of target files without affecting the set of non-target files of the read-only file system, such that the upper layer file system and the read-only file system emulate a merged file system that comprises the update; and
using the emulated merged file system to operate the device.

2. The computer-implemented method according to claim 1, further comprising a second patch image comprising a second set of one or more updated components relative to the first patch image, the second patch image being assigned a higher priority than the first patch image to enable overriding functions of corresponding components in at least one of the read-only file system or the first patch image.

3. The computer-implemented method according to claim 1, wherein applying the upper layer file system comprises, in response to authenticating at least part of the first patch image, installing contents of the first patch image onto a partition, at least a portion of the contents of the upper layer file system on the partition to dynamically produce the emulated merged file system.

4. The computer-implemented method according to claim 3, wherein the partition comprises a read/write section that stores, at least, the upper layer file system in non-volatile memory and uses a script that is passed through a kernel parameter.

5. The computer-implemented method according to claim 3, wherein authenticating comprises using a public key in the boot phase to thwart a tampering attempt.

6. The computer-implemented method according to claim 1, further comprising, upon completion of a firmware update, prior to a subsequent boot phase, re-authenticating at least part of the first patch image, and in response to an authentication failure, aborting one or more updating steps.

7. The computer-implemented method according to claim 1, wherein at runtime of the read-only file system, the one or more files run from the upper layer file system and one or more of the set of non-target files run from the read-only file system.

8. The computer-implemented method according to claim 1, wherein complete replacement of the read-only file system is enabled in response to an authorization.

9. A non-transitory computer-readable medium or media comprising one or more sequences of instructions which, when executed by at least one processor, causes steps to be performed comprising:
receiving a first patch image that comprises one or more files that form an upper layer file system comprising an update for a set of target files for the read-only file system, the read-only file system further comprising a set of non-target files;
in a boot phase, applying the upper layer file system to the read-only file system to mask the set of target files to override the functions of the set of target files without affecting the set of non-target files of the read-only file system, such that the upper layer file system and the read-only file system emulate a merged file system that comprises the update; and
using the emulated merged file system to operate the device.

10. The non-transitory computer-readable medium or media according to claim 9, wherein applying the upper layer file system comprises, in response to authenticating at least part of the first patch image, installing contents of the first patch image onto a partition, at least a portion of the contents forming the upper layer file system on the partition to dynamically produce the emulated merged file system.

11. The non-transitory computer-readable medium or media according to claim 10, wherein the partition comprises a read/write section that stores, at least, the upper layer file system in non-volatile memory and uses a script that is passed through a kernel parameter.

12. The non-transitory computer-readable medium or media according to claim 10, wherein steps further comprise authenticating comprises using a public key in the boot phase to thwart a tampering attempt.

13. The non-transitory computer-readable medium or media according to claim 9, wherein the steps further comprise, upon completion of a firmware update, prior to a subsequent boot phase, re-authenticating at least part of the first patch image, and in response to an authentication failure, aborting one or more updating steps.

14. An information handling system for dynamically updating a read-only file system in a network, the information handling system comprising non-transitory computer-readable medium or media comprising one or more sequences of instructions which, when executed by at least one processor, causes steps to be performed comprising:
in response to receiving a request associated with a firmware update, making available for download to a client device a first patch image that comprises one or more files comprising an update for a set of target files of a read-only file system that comprises a set of non-target files,
wherein, in a boot phase, the upper layer file system is applied to the read-only file system to mask the set of target files to override the functions of the set of target files without affecting the set of non-target files of the read-only file system, such that the upper layer file system and the read-only file system emulate a merged file system that comprises the update.

15. The information handling system according to claim 14, wherein, responsive to the client device communicating an update request, the information handling system initiates an authentication process to authenticate the client device.

16. The information handling system according to claim 14, further comprising:
making available for download to the client device a second patch image that comprises one or more files comprising a second update for a second set of target files of the read-only file system;
wherein the second patch image is assigned a higher priority than the first patch image to enable overriding functions of corresponding components in at least one of the read-only file system or the first patch image.

17. The information handling system according to claim 16, wherein the read-only file system-is read-only except by complete replacement.

18. The information handling system according to claim 14, wherein, responsive to authorizing to the client device, the information handling system makes the first patch image available to the client device.

19. The information handling system according to claim 14, wherein using the one or more files comprises selectively accessing the one or more files and the set of non-target files to emulate the merged file system without copying the files to a single memory location to form the merged file system.

20. The information handling system according to claim 14, wherein the read-only file system is a root file system.
